(19) United States
(12) Patent Application Publication
(10) Pub. No.: US 2017/0339773 A1
(43) Pub. Date: Nov. 23, 2017

(54) INTELLIGENT ILLUMINATOR INTEGRATED WITH LUMINOUS OBJECT

(71) Applicant: Szu-Hsiang Chen, Taipei (TW)

(72) Inventor: Szu-Hsiang Chen, Taipei (TW)

(21) Appl. No.: 15/598,328

(22) Filed: May 18, 2017

(30) Foreign Application Priority Data
May 20, 2016 (TW) 105207491

(51) Int. Cl. H05B 37/02; H02J 7/02; F21V 33/00; F21V 3/04; F21L 4/02; A43B 3/00; A43B 1/00; H05B 33/08; F21V 23/04; F21Y 2115/10

(52) U.S. Cl. CPC H05B 37/0272; H05B 33/0857; H05B 33/0845; H02J 7/025; F21V 33/0008; F21V 23/0414; F21V 3/0409; F21L 4/02; A43B 3/001; A43B 1/0072; F21Y 2115/10

(57) ABSTRACT

An intelligent illuminator Integrated with a luminous object, the illuminator being an independent and removable component, comprising a LED light set, a control unit, a rechargeable battery, a switch and a wireless charging module, which are assembled and sealed to form a waterproof, portable and independent illuminator; the control unit configured to control different lighting mode of the LED light set and including a wireless remote control unit, remotely controlled by a light control APP of an intelligent article; wherein the luminous object includes a transparent or semi-transparent block with light-conducting function and a light-conducting groove; the block is a shoe sole, a lamp holder or a box; the illuminator is placed in the light-conducting groove and can be removed or put in at any time, the intelligent illuminator integrated with a luminous object has the advantages of being widely used and convenient for use.

### BACKGROUND OF THE INVENTION

### (1) Field of the Invention

The present invention relates to an intelligent illuminator integrated with a luminous object.

(2) Description of the Related Art

As the LED is used extensively, many objects have been equipped with LED lamps for decoration, such as luminous shoes, luminous caps and so on. When the LED lamps on the shoes or caps emit light, the objects equipped with LED lamps look dazzling, delighting the users and viewers.

However, the LED lamp on general illuminators is placed in a fixed position of the object, the LED lamp cannot be removed or the mounting position cannot be changed. In different activities or uses, the user cannot remove the LED lamp to other object positions. Taking shoes as examples, jogging wearing jogging shoes at 7 p.m., and walking wearing beach sandals at 9 p.m., if the illuminator is fixed in the jogging shoes, it cannot be removed to the beach sandals, causing inconvenience.

Secondly, the existing luminous shoes must be equipped with charging connection, switch, illuminator and lighting mode switching button. The power conductor shall be connected to the LED illuminator, but the internal or external factors are likely to cause the break of conductor, poor contact even failure in turning on/off and switching light source or charging, resulting in many troubles.

Furthermore, the chargeable batteries for the existing luminous shoes are lithium battery and Li-polymer. As the battery is fixed in the sole, it is likely to fire, burn and explode in the cases of puncture, bending, overcharge and short circuit, the safety shall be considered. The charging connection is required for charging, so the charging is very inconvenient.

In addition, the present luminous shoes can he integrated with color-changeable LED light source, the switch must be pressed for changing the luminous color, the user has to bend down to look for the switch button, and he shall press the button again and again to get the wanted luminous color. To turn power off, the user must bend down to look for the switch button, the operation is very inconvenient.

### SUMMARY OF THE INVENTION

The technical scheme of the present invention is to provide an intelligent illuminator integrated with a luminous object, the illuminator being an independent and removable component, comprising: a LED light set, having a plurality of LED lighting modes; a control unit, disposed at the LED light set and configured to control different lighting mode of the LED light set, the control unit including a wireless remote control unit, remotely controlled by a light control APP of an intelligent article; a rechargeable battery, coupled to a bottom of the LED light set and configured to supply the power for operation; a wireless charging module, coupled to the bottom of the LED light set and configured to charge the rechargeable battery with the received energy by wireless charging method; a switch, disposed on the LED light set and configured to switch on or off the LED light set;

wherein the luminous object comprises a transparent or semi-transparent block with light-conducting function and at least one light-conducting groove configured to hold the illuminator; wherein the light-conducting groove having an inner wall is a light transmissive surface, which is also an incident surface where the light emitted from the illuminator enters the block, and an outside of the block is a light emitting surface;

wherein the illuminator is placed in the light-conducting groove of the luminous object and can be taken out or put in at any time; when the illuminator emits light in the light-conducting groove, the light is directly irradiated to the light transmlssive surface of the light-conducting groove, and then is conducted through the transparent or semi-transparent block and to the outside thereof to form a luminous part

The advantage of the present invention is that the illuminator is waterproof, portable and independent, not fixed m a specific object, so it can be removed to other objects of luminous effect with a light-conducting groove at any time according to the user requirement, such as shoes, lamps, boxes and other independent objects of luminous effect. Therefore, its scope of application is extensive, and the illuminator is not confined to a specific object. Secondly, the wireless charging mode is applied, the illuminator can be charged without taking it out. The light control APP of intelligent articles (e.g. smart phone, smart watch, smart wristlet) can implement different light controls, that is more convenient. The rechargeable battery is high safety FLCB, which is unlikely to fire, burn or explode in the cases of overcharge, bending and puncture.

### BRIEF DESCRIPTION OF DRAWINGS

FIG. 1 is a block, diagram of an intelligence illuminator integrated with luminous object of the present invention;

FIG. 2 is a block diagram of an illuminator of the present invention;

FIG. 3 is a schematic view of a shoe sole with the intelligence illuminator integrated with luminous object of the present invention;

FIG. 4 is a schematic view of an embodiment showing the intelligence illuminator integrated with luminous object applied in a slipper;

FIG. 5 is a schematic view of an embodiment showing the intelligence illuminator integrated with luminous object applied in a casual shoe;

FIG. 6 is a three-dimensional schematic view of the illuminator.

### DETAILED DESCRIPTION OF THE INVENTION

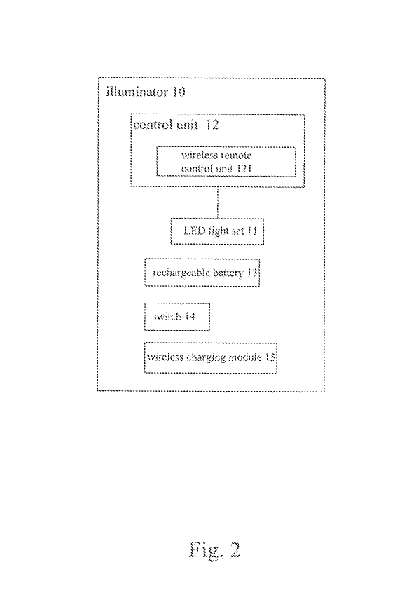

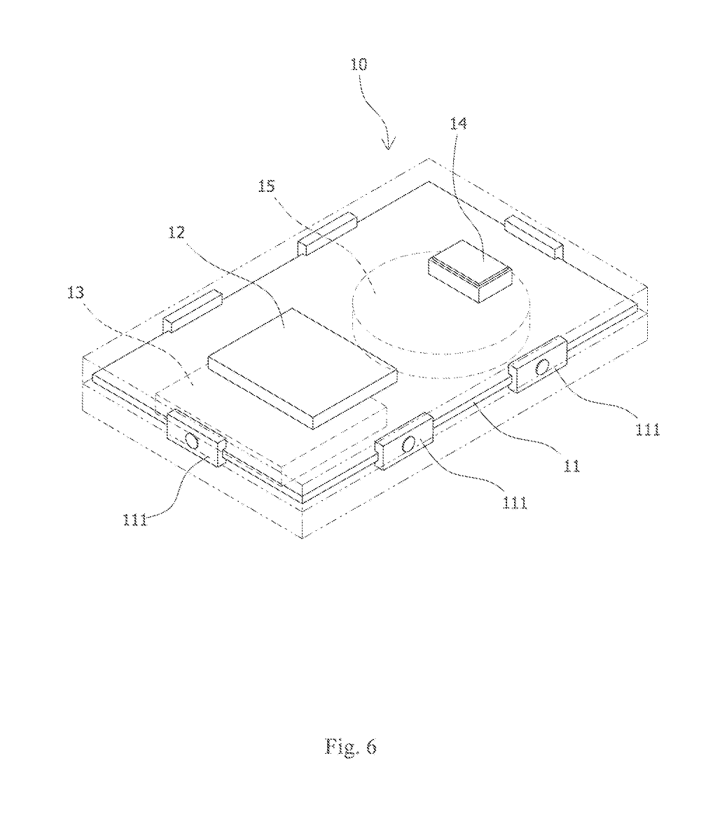

Referring to FIGS. 2 and 6, the present invention provides an illuminator (10) is an independent and removable component, comprising a LED light set (11), a control unit (12), a rechargeable battery (13), a switch (14) and a wireless charging module (15).

The LED light set (11) includes a plurality of LED lighting modes; wherein the LED light set (11) are respectively surrounded by a plurality of LED luminous elements (111). The LED light set (11) can be of any shape, and a light-conducting groove (31) for holding LED light set (11) can be of any shape.

The control unit (12) is disposed at the LED light set (11) for controlling lighting mode of the LED light set (11). The control unit (12) further includes a wireless remote control unit (121), remotely controlled by a light control APP (20) downloaded into an intelligent article (100) from outside, so as to perform relevant control actions. An user uses the light control APP (20) to wirelessly control the control unit (12), so as to control the lighting mode of the illuminator (10), such as the on/off, rolling mode, brightness, frequency. color and chroma of the LED light set (11). Secondly, the wireless remote control unit (121) is a Bluetooth wireless transceiver for connecting the intelligent article (100).

The rechargeable battery (13) is coupled to a bottom of the LED light set (11), electrically connected to the wireless remote control unit (121), control unit (12) and LED light set (11), and supplying the power for operation. The rechargeable battery (13) of the present invention using a high safety FPC Lithium Ceramic Battery (FLCB) is preferred.

The switch (14) is disposed on the LED light set (11) and electrically connected to the control unit (12). The user can use the switch (14) to switch on or off the LED light set (11). The switch 14 can be implemented as a touch switch, so there is no concave or convex disposed thereon that affects the appearance.

The wireless charging module (15) is coupled to the bottom of the LED light set (11), and configured to charge the rechargeable battery (13) with the received energy by wireless charging.

When the above-mentioned elements are assembled, they are sealed by integral molding, or contained in upper and lower mold covers and sealed by high frequency fusion for waterproofing.

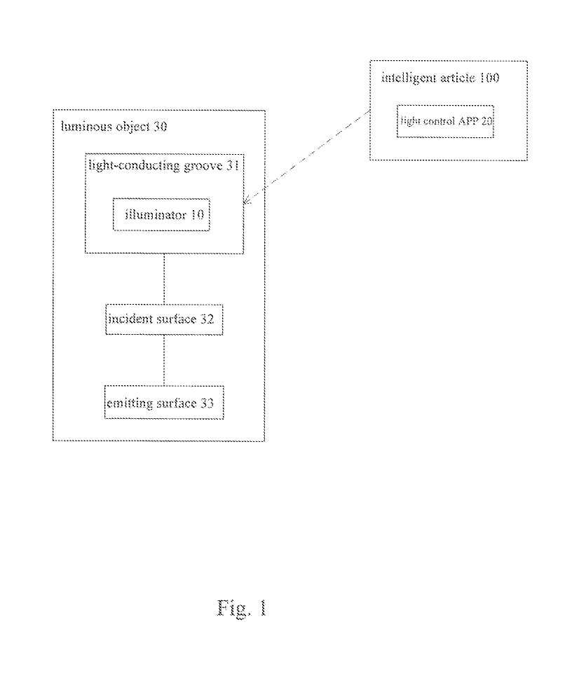

Referring to FIG. 1, the luminous object (30) is a transparent or semi-transparent block with light-conducting function. The block includes at least one light-conducting groove (31) which can hold the illuminator (10). The light-conducting groove (31) having an inner wall is a light transmissive surface, which is also an incident surface (32) where the light enters the block, and the outside of the block is a light emitting surface (33).

The luminous object (30) is made of PU, TPR, TPU or polyrnethaerylate, which has a light-conducting function. The independent illuminator (10) is placed in the light-conducting groove (31) of the luminous object (30) and can be taken out or put in at any time. When the illuminator (10) emits light in the light-conducting groove (31), the light is directly irradiated to the light transmissive surface of the light-conducting groove (31), that is, the light is entered into the incident surface (32) of the block, and then is conducted through the transparent or semi-transparent block and to each side or multiple sides of the block, forming a luminous part. The luminous part is the light emitting surface (33). This condition is like a strip optical fiber. When the light source is admitted in one end (the incident surface) of the optical fiber, the light will be conducted to the other end (the emitting surface) of the optical fiber, so that the other end thereof forms the luminous part. The light is emitted to the outside by the emitting surface (33) so as to achieve eye-catching, warning and safety effects at night.

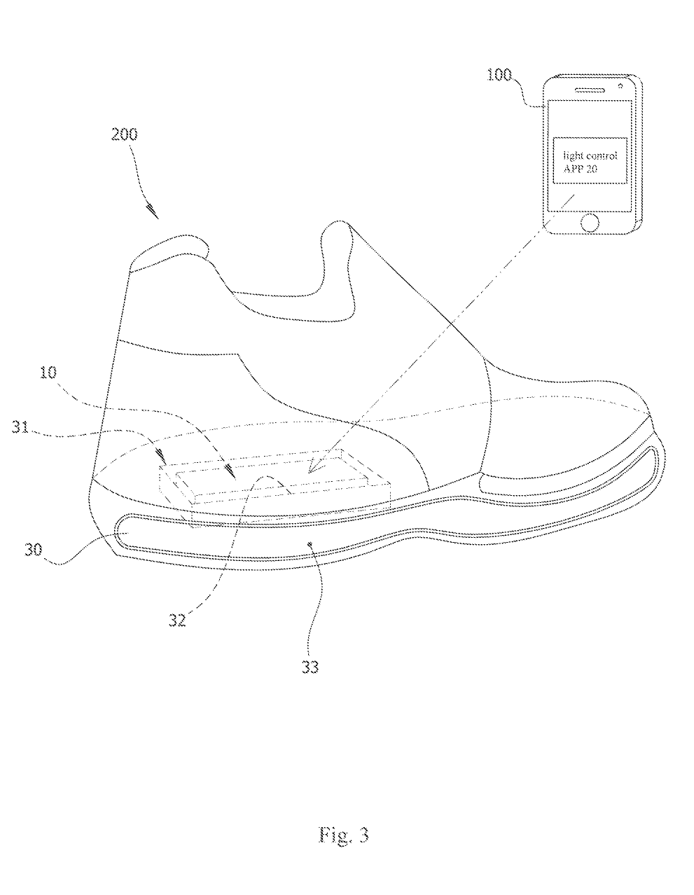

Referring to FIG. 3. The luminous object (30) is a sole, and its periphery is exposed to the outside of the shoe body (200) so that the emitting surface (33) of the luminous object (30) surrounds the outside of the shoe body (200). The luminous object has a top surface covered with an insole and a bottom surface facing downwardly. The illuminator (10) is placed in the light-conducting groove (31) of the luminous object (30) so that it is also covered with the insole. The user can use an intelligent article (100), such as a smart phone, a smart watch or a smart wristlet, and use the light control APP (20) to wirelessly control the control unit (12), so as to switch on the LED light set (11) and control the light source display mode, such as the on/off, alternate flashing mode, brightness, frequency , color and chroma of LED light source.

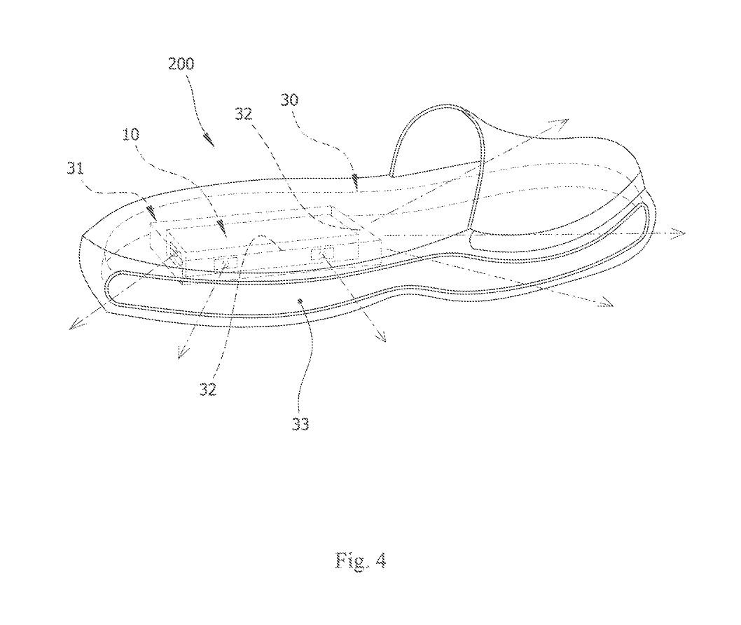

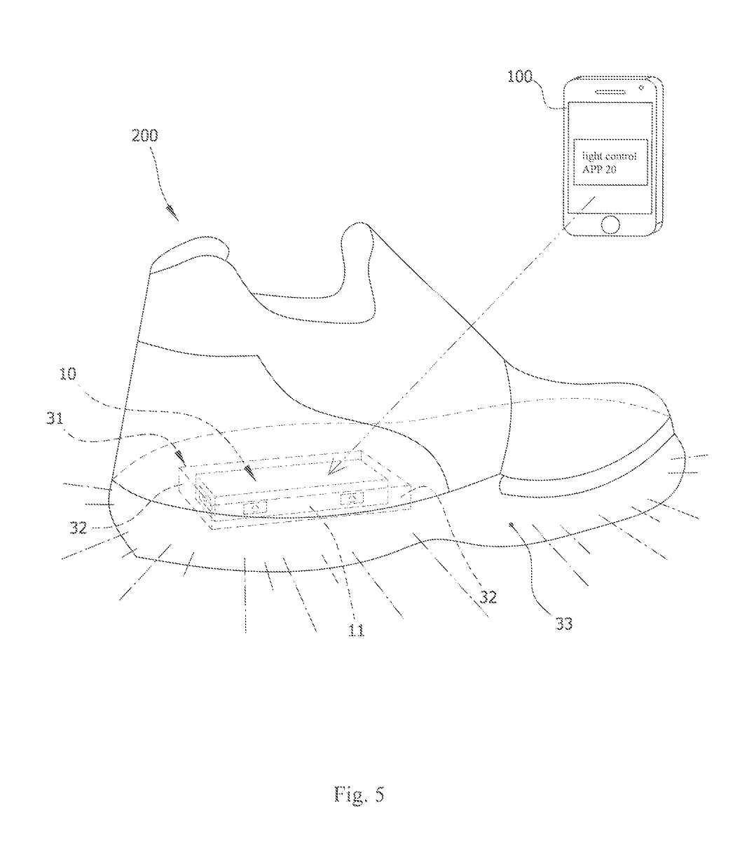

Referring to FIGS. 4-5, the shoe body (200) in FIG. 4 is any one of slippers, beach sandals and flat rubber shoes. The shoe body (200) in FIG. 5 is any one of casual shoes, sports shoes, jogging shoes, mountaineering shoes and rain shoes. The shoe body (200) comprises a body and a sole. Wherein the sole is the luminous object (30) which includes the light-conducting groove (31) to hold the illuminator (10). As the luminous object (30) is made of transparent PU, TPR and TPU, it has excellent light conduction, flexibility and antifriction. The illuminator (10) is disposed in the light-conducting groove (31) of the luminous object (30), and it can be taken out or put in the light-conducting groove (31) of other shoe bodies at any time. Therefore, the illuminator (10) can be put in the shoe body (200) to be worn at any time according to the user requirement. When the illuminator (10) emits light in the light-conducting groove (31), the light is directly irradiated to the light transmissive surface of light-conducting groove (31), that is, the light is entered into the incident surface (32) of the block, and then m conducted through the transparent or semi-transparent block and to each side or multiple sides of the block, forming a luminous part. The luminous part is the light-emitting surface (33).

Said shoe body is an embodiment of the luminous object (30), it can be used in various articles, such as a lamp holder. The lamp holder is a transparent or semi-transparent luminous object. The light-conducting groove is located in a bottom of the holder, and the illuminator is located in the light-conducting groove. The holder is made of polymethacrylate for light conduction, firmness, bearing and protection. In addition, a box, the box having a bottom, is a transparent or semi-transparent block, the light-conducting groove is located in the bottom of the base, and the illuminator is located in the light-conducting groove.

The advantage of the present invention is that the illuminator (10) is waterproof, portable and independent, not fixed in a specific object, so it can be removed to other objects of luminous effect with a light-conducting groove at any time according to the user requirement, such as shoes, lamps, boxes and other independent objects of luminous effect. Therefore, its scope of application is extensive, and the illuminator (10) is not confined to a specific object. Secondly, the wireless charging mode is applied, the illuminator can be charged without taking it out. The light control APP (20) of intelligent articles (e.g. smart phone, smart watch, smart wristlet) can implement different light controls, that is more convenient. The rechargeable battery is high safety FLCB, which is unlikely to fire, burn or explode in the cases of overcharge, bending and puncture.

I claim:

1. A intelligent illuminator integrated with a luminous object, the illuminator being an independent and removable component, comprising:
a LED light set, having a plurality of LED lighting modes;
a control unit, disposed at the LED light set and configured to control different lighting mode of the LED light set, the control unit including a wireless remote control unit, remotely controlled by a light control APP of an intelligent article;
a rechargeable battery, coupled to a bottom of the LED light set and configured to supply the power for operation;
a wireless charging module, coupled to the bottom of the LED light set and configured to charge the rechargeable battery with the received energy by wireless charging method;
a switch, disposed on the LED light set and configured to switch on or off the LED light set;
wherein the luminous object comprises a transparent or semi-transparent block with light-conducting function and at least one light-conducting groove configured to hold the illuminator; wherein the light-conducting groove having an inner wall is a light transmissive surface, which is also an incident surface where the light emitted from the illuminator enters the block, and an outside of the block is a light emitting surface;
wherein the illuminator is placed in the light-conducting groove of the luminous object and can be taken out or put in at any time; when the illuminator emits light in the light-conducting groove, the light is directly irradiated to the light transmissive surface of the light-conducting groove, and then is conducted through the transparent or semi-transparent block and to the outside thereof to form a luminous part.

2. The intelligent illuminator integrated with a luminous object according to a claim 1, wherein the intelligent article is a smart phone, a smart watch or a smart wristlet; the light control APP is downloaded into the intelligent article to wirelessly control the illuminator, so as to control the on/off rolling mode, brightness, frequency, color and chroma of the LED light set.

3. The intelligent illuminator integrated with a luminous object according to a claim 1, wherein the wireless remote control unit is a Bluetooth wireless transceiver for connecting the intelligent article.

4. The intelligent illuminator integrated with a luminous object according to a claim 1, wherein the rechargeable battery is a FPC Lithium Ceramic Battery (FLCB).

5. The intelligent illuminator integrated with a luminous object according to a claim 1, wherein the luminous object is made of PU, TPR, TPU or polymethacrylate, which has a light-conducting function.

6. The intelligent illuminator integrated with a luminous object according to a claim 1, wherein the light-conducting groove and the illuminator are engaged with each other, and can be of any shape.

7. The intelligent illuminator integrated with a luminous object according to a claim 1, wherein the luminous object is a shoe sole having a transparent or semi-transparent block with light-conducting function; the light-conducting groove is located in the insole and corresponding to a wearer's heel.

8. The intelligent illuminator integrated with a luminous object according to a claim 1, wherein the luminous object is a lamp holder having a transparent or semi-transparent block with light-conducting function; the light-conducting groove is located in a bottom of the holder.

9. The intelligent illuminator integrated with a luminous object according to a claim 1, wherein the luminous object is a box having a transparent or semi-transparent block with light-conducting function; the light-conducting groove is located in a bottom of the box.
